(19) United States
(12) Patent Application Publication
(10) Pub. No.: US 2011/0223331 A1
(43) Pub. Date: Sep. 15, 2011

(54) Mesoporous Monoliths Containing Conducting Polymers

(75) Inventors: Brett D. Martin, Washington, DC (US); Michael A. Markowitz, Springfield, VA (US); Brian Melde, Alexandria, VA (US)

(73) Assignee: The Government of the United States of America, as represented by the Secretary of the Navy, Washington, DC (US)

(21) Appl. No.: 12/884,278

(22) Filed: Sep. 17, 2010

Related U.S. Application Data
(62) Division of application No. 11/942,542, filed on Nov. 19, 2007, now abandoned.

(51) Int. Cl. B05D 7/14; B05D 7/00

(52) U.S. Cl. 427/245

(57) ABSTRACT

The present invention relates to a mesoporous monolith containing a conducting polymer such as poly(3,4-ethylenedioxythiophene) and methods for making the monolith. The mesoporous monolith is electroactive, at least semi-transparent and has one or more of a large internal pore surface area, pore size and pore volume. It can be used for various applications in photovoltaics, sensing electrochromics, separations, reversible ion exchange and control of protein activity. The method employs hydrothermal treatment and/or substantially complete drying to obtain the desirable properties of the monolith. Conducting polymer can be covalently bound to the internal pore surfaces and polymerized in situ to partially or completely fill the pores producing increased mechanical strength and a high conductivity per unit area.

### BACKGROUND OF THE INVENTION

The present invention relates to mesoporous monoliths containing conducting polymers and methods for making such monoliths. The mesoporous monoliths are electroactive and may be used for numerous applications including sensing electrochromics, separation processes, reversible ion exchange and control of protein activity.

There is a developing global interest in utilizing extended π-conjugated electrically conducting polymers and oligomers for a wide variety of applications, including throwaway electronic devices such as plastic electrochromic displays, flexible displays, micro- and nanoscale circuitry, lightweight storage batteries, corrosion protective coatings, antistatic coatings, optical sensors, biosensors, chemical sensors, environmental sensors, photovoltaic cells and military applications such as microwave-absorbing materials.

For many of these applications, conducting polymers, such as poly(3,4-ethylenedioxy thiophene) (hereinafter “PEDOT”), offer a number of advantages over conventional metals and conducting inorganic materials. Conducting polymers generally have greater plasticity, greater elasticity, superior processing capabilities, lower mass densities, lower coefficients of thermal expansion, and a greater resistance to chemicals and corrosion. Some conducting polymers also exhibit conductivities similar to that of metals. Furthermore, these conducting polymers are capable of readily switching between two distinct chemical states, a doped conducting state and a dedoped semi-conducting state, via an electrochemical or chemical transformation process.

Because of these properties, conducting polymers are expected to significantly advance the field of photovoltaics and organic light-emitting diodes (OLEDs). Current polymer photovoltaic cells, however, require large amounts of interfacial area between the organic hole-transporting layer and the light-harvesting layer. As a result, polymer-based photovoltaic cells are typically large and have poor conductivities. OLEDs, which are an attractive alternative to liquid crystal display technology because they provide displays that are brighter, relatively inexpensive, consume less power, and are lightweight, unfortunately also require large amounts of interfacial area which negatively impacts the size and conductive capabilities of the OLEDs. Similarly, the large interfacial area requirement is a significant concern for all electrically conducting polymer applications.

Furthermore, there is little information regarding a means for efficiently synthesizing a conducting polymer, such as PEDOT, on a mesoporous scaffold. In the past, mesoporous silica monoliths have been used as templates for the formation of polymers that provide added strength to the monolith (See Mackenzie, J. D.; Bescher, E. P. J. Sol-Gel Sci. Technol. 1998, 13, 371; Pope, E. J. A., et al., J. Mater. Res., 1989, 4, 1018), to synthesize metal nanoparticles (See Dag, O., et al. J. Mater. Chem., 2003, 13, 328-334; Tura, C., et al. Chem. Mater. 2005, 17, 573-579.) or to form an ionically conducting material (See Dag. O. et al J. Mater. Chem. 1999, 9, 1475-1482). While there has been great interest in using mesoporous silicas as templates for the preparation of conducting polymer nanowires (See Molenkamp, W. C., et al. J. Am. Chem. Soc. 2004, 126, 4476-4477; Lin, V. S.-Y., et al. J. Am. Chem. Soc. 2002, 124, 9040-9041; Aida, T., et al. Angew. Chem. Int. Ed. 2001, 40, 3803-3806; Yang, Y., et al. J. Am. Chem. Soc. 2003, 125, 1269-1277; Cheng, O., et al. Micropor. Mesopor. Mater. 2006, 94, 193-199; A. G. Pattantyus-Abraham, et al. Chem. Mater. 2004, 16, 2180; Ruotolo, L. A. M., et al. J. React. Funct. Polym. 2005, 62, 141-151; Pei, Qibing, et al. Polymer 1994, 35, 1347-1351.), these materials are opaque, and the silica serves only as a scaffold that is etched away to obtain the newly formed nanowires. Very little is known regarding the use of monoliths as a polymer scaffold and specifically the use of monoliths as a scaffold for PEDOT.

U.S. Pat. No. 6,946,597 to Sager et al. discloses a photovoltaic device that can be formulated as a porous template. The device comprises a base electrode that may be constructed from a transparent conducting material such as glass with an optional interface layer that may be a conducting polymer such as PEDOT. In one embodiment, the pores of the porous template may be filled with a charge-transfer material and an optional film of PEDOT.

U.S. Pat. No. 7,045,205 to Sager et al. discloses a nanoporous structure including a mesoporous template. The pores of the template may be coated with a variety of polymeric materials. In one embodiment, the patent discloses that it may be desirable to coat or fill the pores with PEDOT.

U.S. Patent Publication No. 2005/018904 to Gaudiana et al. discloses a photovoltaic cell comprising a transparent glass or polymer such as a silica-based glass, a catalyst layer formed from PEDOT and a charge carrier layer formed from imidazole.

Although the Sager et al. patents disclose a porous scaffold incorporating PEDOT, neither the Sager et al. patents nor Gaudiana et al. disclose ways to maximize the interfacial area between the organic hole-transporting layer and the light-harvesting layer. Therefore there exists a need for a conducting polymer-containing template that effectively provides additional interfacial area between the hole-transporting layer and the light-harvesting layer.

### BRIEF SUMMARY OF THE INVENTION

The present invention relates to a novel mesoporous monolith containing a conducting polymer and a method for making thereof. The mesoporous monolith is electroactive and provides a large interfacial area between the hole-transporting layer and the light-harvesting layer.

In one aspect of the invention, the mesoporous monolith comprises a mesoporous substrate, having a conducting polymer covalently bound thereto via an imidazole.

In another aspect, the present invention is directed to a method for fabricating a mesoporous monolith involving the steps of providing a mesoporous substrate precursor, hydrothermally treating the mesoporous substrate precursor, substantially completely drying the mesoporous substrate precursor to form a mesoporous substrate, and binding a conducting polymer to at least a portion of the internal surface of the pores of the mesoporous substrate to form a mesoporous conducting polymer-containing monolith.

In a third aspect, the present invention is directed to a method for fabricating a mesoporous monolith involving the steps of providing a mesoporous substrate precursor, forming a mesoporous substrate from the mesoporous substrate precursor, covalently attaching imidazole to a surface of the mesoporous substrate, and providing a conducting polymer by in situ polymerization to form a mesoporous conducting polymer-containing monolith.

### BRIEF DESCRIPTION OF THE DRAWINGS

FIG. 1 is a schematic diagram of a mesoporous substrate containing a conducting polymer;

FIG. 2 shows that monoliths containing conducting polymer can be changed from a doped state to a dedoped state;

FIG. 3(a) shows the chemical reaction which occurs when poly(3,4-ethylenedioxythiophene) (hereinafter “PEDOT”) goes from a dedoped state to a doped state using an electrochemical process;

FIG. 3(b) shows the chemical reaction which occurs when polythiophene goes from a dedoped state to a doped state using an electrochemical process;

FIG. 4 is a diagram of method for fabricating a doped mesoporous PEDOT monolith;

FIG. 5 shows the chemical reaction involved in the oxidative polymerization of PEDOT;

FIG. 6 is a graph of current as a function of potential;

FIG. 7 is a graph of EDOT-PEDOT monolith mass uptake as a function of time, with an inset graph of the UV-visible spectra of the finished monolith containing PEDOT;

FIG. 8 is a graph of EDOT concentration as a function of diffusion distance, showing steady-state levels achieved during EDOT polymerization to PEDOT;

FIG. 9(a) is a graph of incremental pore volume as a function of diameter;

FIG. 9(b) is a graph of nitrogen absorption as a function of P/P₀;

FIG. 9(c) is a diagram of exemplary occluded and barren portions of PEDOT coverage;

FIG. 10 is a graph of weight fraction as a function of temperature, during thermogravimetric analysis;

FIG. 11 is a graph of current as a function of potential;

FIG. 12 is a graph of current as a function of potential;

FIG. 13 is a graph of peak current as a function of scan rate;

FIG. 14 is graph of current as a function of potential.

### DETAILED DESCRIPTION OF THE INVENTION

For illustrative purposes, the principles of the present invention are described by referencing various exemplary embodiments thereof. Although certain embodiments of the invention are specifically described herein, one of ordinary skill in the art will readily recognize that the same principles are equally applicable to, and can be employed in other compositions and methods. Before explaining the disclosed embodiments of the present invention in detail, it is to be understood that the invention is not limited in its application to the details of any particular embodiment shown. The terminology used herein is for the purpose of description and not of limitation. Further, although certain methods are described with reference to certain steps that are presented herein in certain order, in many instances, these steps may be performed in any order as may be appreciated by one skilled in the art, and the methods are not limited to the particular arrangement of steps disclosed herein.

The present invention is directed to an electroactive, mesoporous monolith containing conducting polymer and methods for making such monoliths. The mesoporous monolith may be at least semi-transparent or it may be transparent.

The mesoporous monoliths of the present invention may have a large internal pore surface area, a large pore size and a large pore volume which together provide the ability to functionalize the monolith and obtain exceptional conducting properties which render it suitable for a number of different applications including throwaway electronic devices such as plastic electrochromic displays, flexible displays, micro- and nanoscale circuitry, lightweight storage batteries, corrosion protective coatings, antistatic coatings, optical sensors, biosensors, chemical sensors, environmental sensors, photovoltaic cells and military applications such as microwave-absorbing materials.

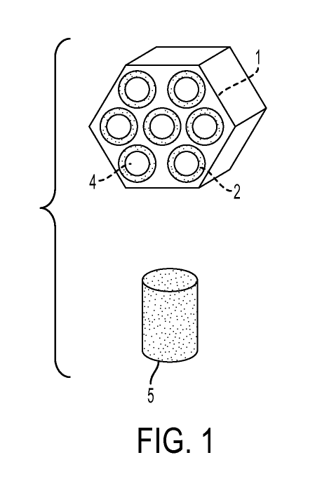

In an exemplary embodiment shown in FIG. 1, the mesoporous monolith of the present invention includes a mesoporous substrate 1, an electroactive polymeric conducting layer 2 and a binding layer 3 that anchors the polymeric conducting layer to the silica substrate. The mesoporous substrate 1 may be composed of any suitable material. Preferably, the mesoporous substrate is composed of at least one organic semiconductor, at least one inorganic semiconductor or a mixture thereof. More preferably, the mesoporous substrate material may be a silica compound, such as porous silica, polydimethylsiloxane (PDMS), periodic mesoporous organosilicas, and other silica sol gels, CdTe, CIGS (copper indium gallium selenide), mesoporous/macroporous organic polymers such as poly(methylmethacrylate), and mixtures thereof. These materials may have a crystalline, poly-crystalline or amorphous structure. Preferably, the material is at least semi-transparent or transparent. Additionally, the mesoporous substrate may also cooperate with a macroporous support matrix that would enable rapid diffusion of electrolytes into the mesopores.

The mesoporous substrate 1 may have a large network of pores 4 which may be either regularly or irregularly spaced. Pores 4 may have large diameters, large internal pore surface areas and large pore volumes. An exemplary mesoporous substrate may have an average pore diameter ranging from about 1 nm to about 50 nm, more preferably, from about 5 nm to about 20 nm and, most preferably, from about 5 nm to about 10 nm.

An exemplary mesoporous substrate 1 may also have a large internal pore surface area of from about 50 m²/g to about 600 m²/g, more preferably, from about 200 m²/g to about 400 m²/g and, most preferably, from about 300 m²/g to about 400 m²/g. An exemplary mesoporous substrate may also have a pore volume of about 0.7 cm³/g to about 1.0 m²/g and, more preferably, from about 0.925 cm³/g to about 0.95 m²/g. Without wishing to be bound by theory, the highly porous nature of the mesoporous substrate 1 may increase the available internal surface area of the pores 4 to which conducting polymer may be bound or attached thereby allowing an increase in conductivity due to the presence of additional conducting polymer Additionally, the larger pore sizes facilitates modification of the surfaces of pores 4 without clogging openings of pores 4.

At least one electroactive polymeric conducting layer 2 is formed on mesoporous substrate 1. This conducting polymer monolayer or multilayer 2 may coat all or any portion of the surface of the mesoporous substrate 1, including the internal surface of the pores 4. In an exemplary embodiment, the thickness of the conducting polymer layer can range from a few angstroms to 10 nm or more. To enhance the mechanical strength of mesoporous substrate 1 and increase ordering of the polymer chains, a polymeric conducting layer 2 may be formed in ordered and unordered mesoporous and macroporous substrates.

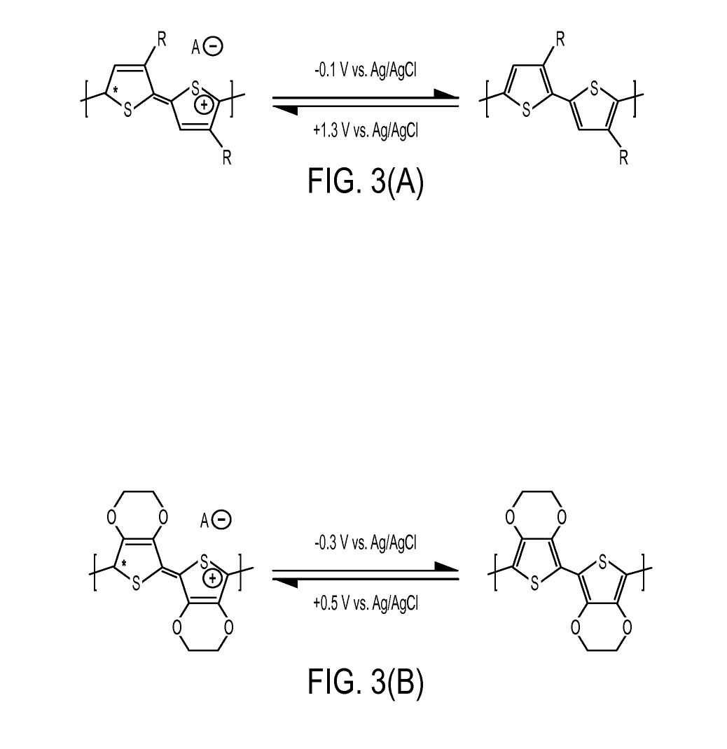

The present invention may employ any conducting polymer whose monomer has an oxidation potential less than or equal to that of the immobilized oxidized metal. Preferably, the conducting polymer is constructed from PEDOT, polythiophene (PTP), polypyrrole or polyaniline. PTP is a switchable electrochromic window material. FIG. 3(b) shows the electrochemical transformation of PTP from its doped state to its dedoped state. The conducting polymer polypyrrole has previously been successfully used as an electroactively switchable stationary-phase material for chromatography, and the conducting polymer polyaniline has been used as an electroactively switchable ion exchange resin for reduction and removal of hexavalent chromium. The conducting polymer may include mixtures of the foregoing conducting polymers. Mixtures of two or more polymers can be used to alter various properties of the monolith including at least the conductivity, mechanical strength and elasticity.

PEDOT is a particularly advantageous material since it is stable, highly conductive, has high transparency and is easy to derivatize. By comparison, other conducting polymers such as polypyrrole have a lower conductivity and may be less stable than PEDOT. Polyaniline also has lower conductivity, is difficult to derivatize and has lower transparency than PEDOT.

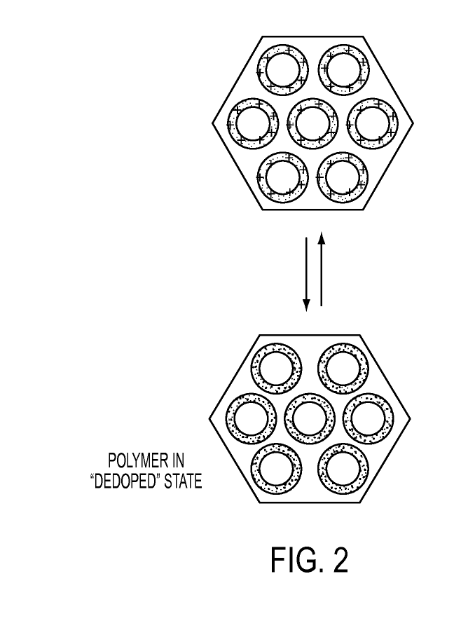

Conductive polymers may exist in two chemically distinct states, a doped conducting state and a dedoped semi-conducting state and may be switchable from the doped state to the dedoped state and from the dedoped state to the doped state. The doped state typically contains radical cations, i.e. polarons and/or bipolarons, and is π-conjugated, with associated counterions. By contrast, the dedoped state is typically electrically neutral and aromatic. FIG. 2 further illustrates the switchable nature of some conductive polymers, demonstrating that such materials can be reversibly cycled from a doped state to a dedoped state via an electrochemical or chemical transformation process. The mesoporous conducting polymer containing substrate shown in FIG. 2 has a pore diameter of about 25 nm and internal pore surface area of about 500 m²/g. 1 gram of the monolith, i.e. about 2 cm³, contains about 4500 square feet of accessible, switchable surface area.

FIG. 3(a) shows the electrochemical transformation of PEDOT from it doped to dedoped state and the half-wave redox potentials associated with the two states. The R group may be hydroxyalkyl, alkoxy or alkyl.

The mesoporous monolith of the present invention may include a binding material which may be in the form of a binding layer 3. The binding layer 3 may be composed of any suitable materials for binding conducting polymer to mesoporous substrate 1 including pyridines, other nitrogen-containing materials, nitriles, cyano-compounds and carboxylates. Preferably, the binding layer includes imidazole moieties.

The mesoporous monolith of the present invention has numerous desirable properties. In addition to its large internal pore surface area, pore size and pore volume, it is may also be rendered electroactive by introducing electrolytes into the pores. The electroactive conductive layer may be reversibly “switched” from its doped, polycationic, conjugated conducting form to its de-doped, aromatic, semiconducting form. A small volume of the mesoporous monolith, i.e. about 2 cm³, thus represents several hundred square meters of electrically switchable surface area. The overall dimensions of the mesoporous monolith may range from several mm per side to about 1 cm per side.

The mesoporous monolith may also have a low effective resistance. In an exemplary embodiment, the resistance of the mesoporous monolith may range from about 1 MΩ/mg to about 1 Ω/mg, more preferably from about 1 kΩ/mg to about 1 Ω/mg and, most preferably, below about 100 Ω/mg. In an exemplary embodiment, the transparency of the samples with this electroactivity is about 12-15%, more preferably, about 11-14% at a wavelength of 800 nm.

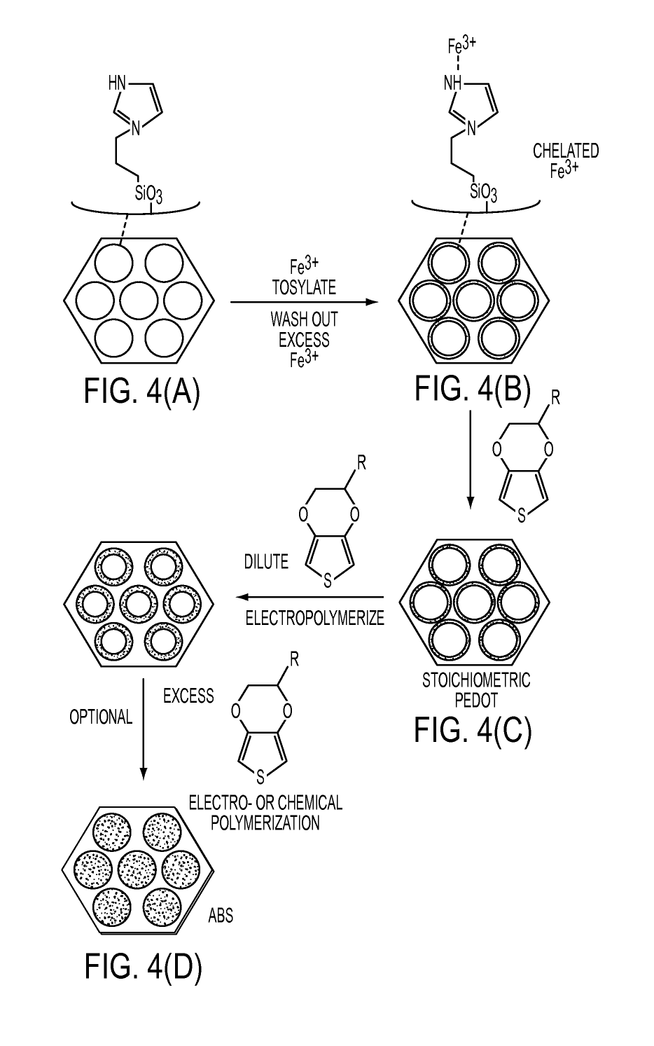

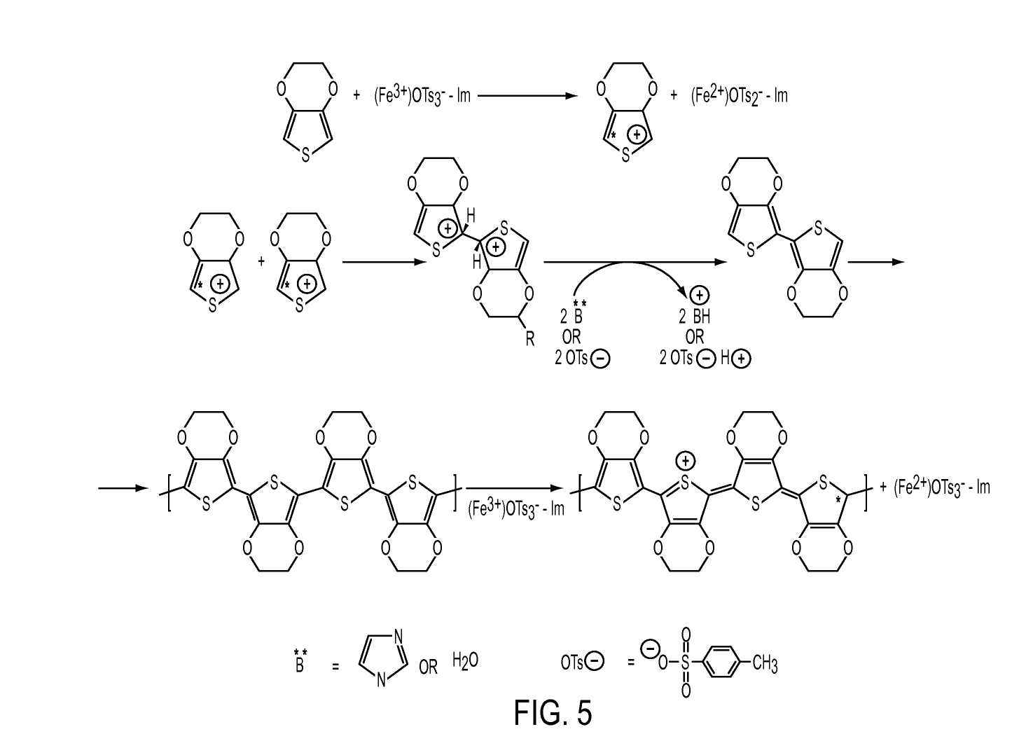

The mesoporous monolith of the present invention may be formed using a novel method that enables the formation of large internal pore surface area, pore size and pore volume. As shown in FIG. 4, an exemplary method of the present invention involves the steps of: (a) synthesizing a mesoporous substrate with covalently attached imidazole, (b) functionalizing the mesoporous substrate with chelated ions, (c) stoichiometrically synthesizing PEDOT in the mesoporous monolith, and (d) chemically polymerizing or electropolymerizing additional EDOT.

The mesoporous substrate may be synthesized from a mesoporous substrate precursor, which for purposes of this application may be any conventional precursor gels, sols, or mixtures thereof, using standard porous substrate preparation methods. An alcohol component may be added to the mesoporous substrate precursor during synthesis as a porogen. Preferably, the alcohol component may be any suitable or conventional material such as ethylene glycol. More preferably, the alcohol is glycerol. Glycerol is an advantageous porogen since it can be easily removed by dissolving in water, enabling the formation of clear mesoporous gels without calcination or refluxing in solvent.

The mesoporous substrate precursor is then immersed in water for a sufficient amount of time to enable water absorption. The saturated mesoporous substrate precursor is hydrothermally treated enabling the mesoporous substrate precursor to swell. The mesoporous substrate precursor is then stored under alcohol, aqueous alcohol and water so that it ages without substantial cracking, and the porogen may be removed from the substrate. The subsequent mesoporous substrate precursor may then be heated, or less preferably, held under a vacuum at room temperature, until it becomes substantially completely dry to form the mesoporous substrate. In an exemplary embodiment, the mesoporous substrate precursor is heated at about 70° C. to about 90° C., more preferably, at about 80° C. to about 90° C. When substantially completely dried, the mesoporous substrate shrinks by up to about 50%, alternatively, up to about 40%, and may cause large monoliths to crack. Despite cracking, the resulting mesoporous substrate pieces remain transparent or semi-transparent and are useful for their intended purpose.

The mesoporous substrate may then be derivatized with a covalently attached imidazole. A chelating and oxidation-moderating imidazole may be introduced as a functional group in a mesoporous substrate precursor. Alternatively, the chelating and oxidation-moderating imidazole may be grafted onto the mesoporous substrate after the formation of the mesoporous substrate.

Without wishing to be bound by theory, the heating and drying conditions may significantly affect the major pore size, pore volume, internal pore surface area and transparency of the resultant mesoporous substrate. Pore size may be controlled by hydrothermal treatment or drying at high temperature. A mesoporous substrate that is hydrothermally treated and dried appear to have a substantially larger internal pore surface area, pore size and pore volume in comparison to mesoporous substrates that were not hydrothermally treated and/or not dried at high temperatures. Mesoporous substrate precursors which were not hydrothermally treated and dried at room temperature have near perfect optical transparency; those that are hydrothermally treated or dried at higher temperatures are semi-transparent but remain substantially transparent and thus are sufficiently transparent for use.

Conventional methods for producing mesoporous monoliths intentionally avoid substantially complete drying of the mesoporous substrate, presumably because it would cause cracking and loss of monolithic shape. In comparison to monoliths produced by the method of the present invention, mesoporous substrates which are incompletely dried have smaller internal pore surface areas and pore volumes. Although it is possible to fabricate large monoliths having centimeter dimensions if the mesoporous substrate is not dried completely, this is difficult to accomplish with surfactant or block copolymer templated substrate precursors, particularly with surfactant or block copolymer templated silicas; the process of removing the template will often crack or crumble such a mesoporous substrate precursor into powder.

As shown in step (b) of FIG. 4, after the imidazole-containing monolith is formed, transition metal salt ions, such as Ce4⁺ or iron (III) salt, or those containing Sc(III), Cr(IV), Mn(III), Co(III), Ni(II), Cu(III), Ru(III), Sn(IV), or those of the Lanthanide series, or Nd(III), Sm(III), Gd(III), Eu(III), Yb(III), or Lu(III) may be introduced and captured, i.e. chelated, by the imidazole, thereby functionalizing the mesoporous substrate. Other suitable salts that may be chelated by the imidazole can also be used. The excess salt is then removed by soaking the monolith overnight.

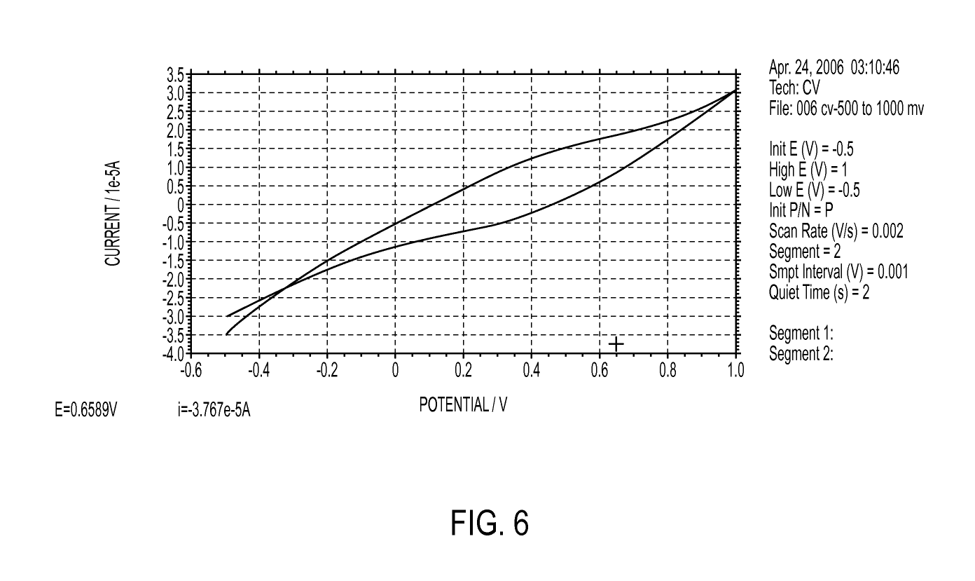

The functionalized mesoporous substrate is subsequently immersed in EDOT, which may be introduced either in an organic solvent or neat as liquid at room temperature. The imidazole covalently binds the mesoporous monolith to the EDOT. The imidazole-Fe complex serves as a stoichiometric oxidant for the polymerization of EDOT monomer. Each C—C bond formed in PEDOT requires reduction of two iron (III) atoms, see FIG. 6. When the mesoporous substrate is heated to about 110° C. for about 20 minutes, a thin layer of PEDOT is formed on the pore walls via oxidative polymerization, as shown in step (c) of FIG. 4. Upon polymerization, the resultant mesoporous monolith becomes colored, i.e. blue-green or orange, depending on synthesis conditions, but also remains semi-transparent or transparent. If the reactant-containing solution is cast onto a suitable substrate such as plastic or glass and then heated, highly conducting insoluble blue doped films are formed with near-metallic conductivities of as high as 800 S/cm, and optical transparencies as high as 85%. The process allows, in one quick single step, the formation of a thin doped polymer film which possesses a high conductivity and transparency. The monolith may then be immersed in a suitable solvent to allow any excess reactants and by-products to diffuse out. The resulting PEDOT monolith retains a substantial amount of its mesoporosity after introduction of PEDOT, preferably, at least about 60% of its mesoporosity is retained, more preferably, at least about 80% of its mesoporosity is retained. In an exemplary embodiment, the monolith retains at least about 85% of its mesoporosity.

As shown in step (d) of FIG. 4, additional EDOT can be introduced and either chemically or electrochemically polymerized, thickening the PEDOT layer, or completely filling the pores, if desired. This process of thickening the PEDOT layer or filling the pores maximizes the amount of PEDOT that can be formed in or on the mesoporous monolith and thereby increases the conductivity which can be obtained for a given sized monolith. By repeat impregnation of the mesoporous substrate with EDOT, it is therefore possible to control and reduce pore size by filling the pores with PEDOT to varying degrees. This mesoporous substrate fabrication method therefore enables size selective adsorption, which might not otherwise be expected using glycerol as a porogen.

After formation, the mesoporous PEDOT-containing monolith may be either chemically or electrochemically transformed into either its doped or dedoped state as desired. It is also possible to reversibly switch between these two states via an electrochemical process. In an electrochemical transformation, an electrical bias ranging from −0.5 to 1.3 Volts (vs. Ag/AgCl) may be applied to the PEDOT. As shown in FIG. 3(a), the high voltage induces the appearance of the doped state; the low voltage induces the appearance of the dedoped state.

In chemical doping, the dedoped polymer is exposed to a solution containing an oxidant, such as a transition metal salt, i.e. iron (III). PEDOT may then be oxidized to its doped state with concomitant formation of iron (II). Alternatively, imidazole may be used as a doping agent. In chemical dedoping, doped PEDOT is exposed to a solution or vapor containing a reducing agent such as hydrazine. The reductant supplies electrons to PEDOT, transforming it to the dedoped state.

The resulting mesoporous PEDOT monolith of the present invention has a number of advantageous features. It is particularly desirable because the monoliths may be transparent, have superior conductivity and may have unprecedented large internal pore surface area, pore size and pore volume. The high degree of mesoporosity and optical clarity of the gels provide much potential for sensing applications including photovoltaics, sensing, electrochromics, separations, reversible ion exchange, and in strategies for control of protein activity. Without wishing to be bound by theory, these desirable properties may be achieved, in part, as a result of the control over the novel heating and drying conditions of the methods of the present invention used for the formation of the mesoporous substrate.

The retention of relatively high internal pore surface area also allows the pores of the substrate to be coated with large amounts of PEDOT, synthesized in situ. The PEDOT may serve as a mechanical reinforcement as well as an electroactive component, contributing to the robustness and structural integrity of the monolith. Furthermore, in comparison to older materials that appear in powder form due to a lack of mechanical integrity, the interpolated mesoporous network of the present invention enables the monolith to maintain its structural integrity during formation.

Another advantage of the present invention is the use of covalently attached imidazole, which allows chelation of a metal atom, which in turn participates in the stoichiometric oxidative polymerization of EDOT. This process allows a true monolayer or near-monolayer of PEDOT to be formed on the pore walls, if desired. The remainder of the pore remains open and accessible for other uses. Additionally, the covalently attached imidazole allows retention of sufficient monolith transparency during fabrication. The retention of monolith transparency during the in situ PEDOT formation appears to depend on having the imidazole component attached to the pore walls, rather than free in the polymerization solution.

### Example 1

In one embodiment, the present invention is directed to a mesoporous silica PEDOT monolith. The mesoporous silica PEDOT monolith may be fabricated in accordance with the following method which involves first synthesizing a mesoporous silica monolith from silica gels or sols and subsequently polymerizing conductive EDOT onto the surface of the monolith.

Silica gels were prepared from mixtures, or sols, with a molar ratio of about 1 Si:3.68 methanol:2.16 glycerol:0.00447 sodium hydroxide:4.96 water. About 1.5 g of glycerol (GLY) was dissolved in about 2.25 mL of tetramethyl orthosilicate (TMOS) and 2.25 mL of methanol (MeOH) at about room temperature. About 1.35 mL of 0.05 M aqueous sodium hydroxide (NaOH) was added to hydrolyze the TMOS silica precursor. The sol formed a gel within 5 minutes. The gel was then covered with a layer of MeOH for about 18 hours. The MeOH was replaced with a series of liquids, one having a volume ratio of about 3 MeOH:1 H2O (water) for 24 hours and a second liquid having a volume ratio of about 1 MeOH:1 H₂O for 24 hours. The gel was then covered with H₂O and heated to about 80° C. for about 2 days and covered by a fresh layer of water for about 1 more day. Swelling of the gel was observed upon hydrothermal treatment. The gel was stored under alcohol, aqueous alcohol, and water so that it aged without cracking and so that it dissolved the glycerol to form the mesopores of the substrate. Removal of glycerol was confirmed by thermogravimetric analysis using a TA Instruments TGA (New Castle, Del.) and mesoporosity was confirmed by nitrogen adsorption experiments on dried gels.

The gel was allowed to completely dry at 80° C. Alternatively, it could have been dried under a vacuum at room temperature. This typically causes the gel to shrink by up to about 50% and causes large monolithic samples to crack. Despite cracking, the gel pieces were transparent or translucent.

After formulation of the silica monolith, PEDOT was synthesized along the surface and pores of the monolith. This process involves derivatizing the silica substrate with N-3-(triethoxysilylpropyl)-4,5 dihydroimidazole in a molar amount greater than the estimated number of surface SiOH hydroxyl groups available. The dried monolith was immersed in about 0.1 M N-(3-triethoxysilylpropyl)-4,5-dihydroimidazole in MeOH at about 50° C. for about 18 hours, rinsed copiously with MeOH, and dried under vacuum. The permanent yellowish cast of the monolith, which was similar to that of the pure imidazole silane, and the measured decrease in mesoporosity evidenced the successful functionalization of the silica monolith. For example, a properly functionalized gel with an original internal pore surface area of about 428 m²/g, a pore volume of about 1.05 cm³/g, and a pore size of about 144 Å subsequently has a decreased internal pore surface area of about 365 m²/g, a pore volume of about 0.628 cm³/g, and a pore size of about 88 Å due to partial filling of the pores with PEDOT.

For PEDOT synthesis on the mesopore walls, about 80 mg Ce(IV)(SO₄) was dissolved in about 2 ml of a 1.5:1.5:1.0 (by volume) deionized water (DI):sulfuric acid:DMF solution by heating the mixture to about 110° C. for about 10 minutes to form a bright orange solution. The solution was allowed to come to room temperature before the silica monoliths, having an approximate dimension of about 1 cm×0.5 cm×0.1 cm, were immersed in the solution for about 30 minutes with gentle stirring. The monoliths were then immersed in a fresh DI water:sulfuric acid:DMF solution, without the presence Ce(IV)(SO₄). The solution was also stirred vigorously for about 1 minute to remove any excess, unchelated Ce(IV). The monolith was further immersed in 1-propanol and stirred vigorously to remove traces of the acidic wash solution before being placed in a 2 ml microcentrifuge tube, into which about 1.5 ml of an EDOT solution (2.5 wt % in 1-propanol) was introduced. The solution was repeatedly drawn into a syringe and discharged at the rate of 1 cycle/2 sec, creating a forced convection of the solution over the surface of the monolith. As the EDOT polymerized within the mesopores of the monolith, the monolith gradually turned pale blue within about 15 seconds and subsequently dark blue within about 60 seconds, while retaining its transparency. Polymerization occurred in a stoichiometric fashion, transforming Ce(IV) to Ce(III) and polymerizing EDOT to PEDOT, which was retained on the mesopore walls. The PEDOT exhibited a characteristic dark blue color. Any unreacted EDOT was removed from the monolith by immersing it in vigorously stirred 1-propanol for about 2 minutes, and the monolith was allowed to soak overnight in 80/20 1-propanol/H2O containing 2 wt % EGTA for the final extraction of chelated cerium species.

### Example 2 and Comparative Examples A and B

Through experimentation, it has been determined that heating and drying conditions determined the resultant major pore size, pore volume, internal pore surface area and transparency of the monolith gel. A comparative study demonstrated that a silica gel (Comparative Example A) which was not hydrothermally treated and only dried at room temperature, but was otherwise formed according to the method of Example 1, had a Brunauer-Emmett-Teller (BET) calculated internal pore surface area of about 615 m²/g, a Barret-Joyner-Halenda (BJH) pore volume calculated from the adsorption branch of a nitrogen sorption isotherm of about 0.637 cm³/g, and a wide BJH pore size distribution centered at about 45 Å. A silica gel (Comparative Example B) that was not hydrothermally treated but dried at 80° C., but was otherwise formed according to the method of Example 1, exhibited a BET internal pore surface area of about 320 m²/g, a BJH pore volume of about 0.945 cm³/g, and a well-defined pore size (narrower distribution) of about 143 Å.

By contrast, a silica gel (Example 2) that was hydrothermally treated, dried at 80° C. and formed in accordance with the method of Example 1, had a BET internal pore surface area of about 310 m²/g, a BJH adsorption pore volume of about 0.941 cm³/g, and a BJH pore size of about 172 Å. All monolith internal pore surface area and pore volumes were calculated using standard BET nitrogen adsorption methods using a Micromeritics ASAP 2010 (Norcross, Ga.). Gels which were not hydrothermally treated and dried at room temperature have perfect optical transparency; those that are hydrothermally treated or dried at higher temperatures are translucent but remain substantially clear.

### Example 3 and Comparative Examples C and D

Various mesoporous silica monoliths were produced using different methods for synthesizing PEDOT in silica monoliths. The results demonstrate that covalently attached imidazole PEDOT significantly enhances electrical conductivity.

In comparative example C, a monolith without covalently-attached imidazole was soaked in 0.1 M iron (III) tosylate and about 0.1 M imidazole in 2-propanol for about 2 hours. The monolith gradually turned yellowish as the iron diffused into the pores. The monolith was then placed in a vial containing about 10 ml 2-propanol with 5% v/v EDOT, which was heated at 110° C. for 20 minutes. It subsequently turned an opaque deep blue as EDOT diffused inwardly and was polymerized. The resultant silica-PEDOT monolith was then allowed to soak in 2-propanol overnight to any remove excess reactant and by-products and dried at room temperature. Its electrical resistance was measured and found to be about 1MΩ.

In comparative example D, a monolith containing covalently-attached imidazole was soaked in 0.1 M iron (III) tosylate in 1-butanol for about 2 hours. The monolith gradually turned yellowish as the iron diffused into the pores. The monolith was then placed in a vial containing about 10 ml 1-butanol with 5% v/v EDOT, which was heated at about 110° C. for about 30 minutes. The monolith subsequently turned a transparent deep orange as EDOT diffused inwardly and was converted to oligomers. The oligomers, however, were evidently not PEDOT, which turns various shades of blue in its doped state or blue-violet in its dedoped state. The monolith was then allowed to soak in 1-butanol overnight to remove excess reactant and by-products, and dried at room temperature. The resulting monoliths have a very high electrical resistance when dry, indicating that the oligomers were physically isolated from one another within the monolith.

In Example 3, monoliths containing covalently-attached imidazole were soaked in 0.1 M iron (III) tosylate in 2-propanol for about 2 hours and gradually turned yellowish as the iron diffused into the pores. The monolith was then allowed to soak in 2-propanol overnight to remove any unchelated iron. They were then placed in a vial containing 0.5 ml of neat EDOT which was then heated at about 110° C. for about 30 minutes. The monolith subsequently turned a transparent blue-green as EDOT diffused inwardly and was converted to a polymer. It was then allowed to soak in 2-propanol overnight to remove any excess reactant and by-products, and dried at room temperature. The monolith had an electrical resistance of about 1.4-2.0 MΩ when dry, indicating that the polymer had a degree of interconnectivity through the mesopores while monolith transparency was retained.

The cyclic voltammogram of FIG. 6 demonstrates that the monolith of Example 3 was electroactive and “switchable” between the doped and dedoped states, with half-wave potentials of about 0.381 V at 3.9 μA (anodic, doping) and about 0.377 V at 3.52 μA (cathodic, dedoping).

### Comparative Example E

The internal pore surface area and sample size of a mesoporous silica sol-gel monolith which had been aged only at room temperature and had not been allowed to completely dry was investigated. Samples were ground into powders and subjected to nitrogen adsorption-desorption analysis. The samples were found to have a BET internal pore surface area of 232 m²/g, a pore volume of 0.24 cm³/g, and a pore size of 47 Å. This internal pore surface area and pore volume was considerably smaller than those attained with the gels of the present invention.

### Example 4

In one monolith synthesis procedure, silica starting monoliths were derivatized with imidazole. Ce(IV)(SO4) was introduced in 1.5:1.5:1.0 v:v:v DI water:sulfuric acid:DMF solution by heating at 110° C. for 10 min to form a bright orange solution. The solution was allowed to come to room temperature, and the silica monolith (approximate dimensions 1 cm×0.5 cm×0.1 cm) was immersed in the solution for 30 min with gentle stirring. The monolith was then immersed in fresh DI water:sulfuric acid:DMF solution (no Ce(IV)(SO₄) present) which was stirred vigorously for 1 min to remove excess unchelated Ce(IV) while leaving imidazole-chelated Ce(IV) bound to the pore walls. EDOT in 2.5 wt % in 1-propanol was introduced next, and it was allowed to polymerize in a stoichiometric fashion at room temperature on the pore walls. Unreacted EDOT was removed, and the monolith was allowed to soak in 80/20 1-propanol/H₂O containing 2 wt % EGTA for extraction of cerium species. After drying, a corner of the monolith was broken off, and the fracture surface showed polymerization through the thickness of the monolith.

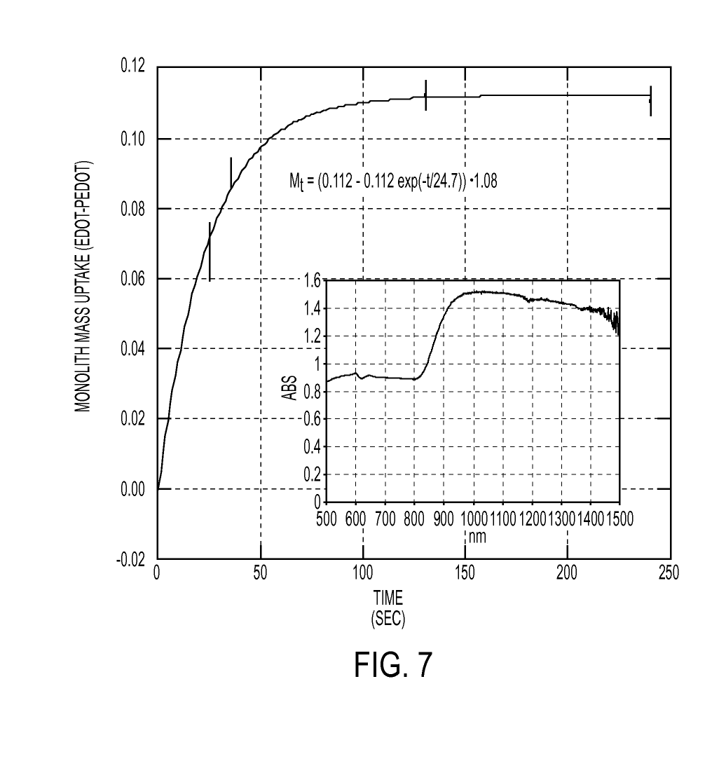

FIG. 7 shows an increase in PEDOT mass in monoliths wherein the polymer is synthesized using forced convection of a 5 wt % solution (100 μl in 3 ml 1-PrOH) of EDOT in 1-propanol containing the starting monolith. The graph of mass increase as a function of time was fit to the function M^{t}=(0.112-0.112 exp(−t/24.7))*1.08. The inset graph of absorption a function of wavelength shows the UV-visible spectrum of the finished monolith.

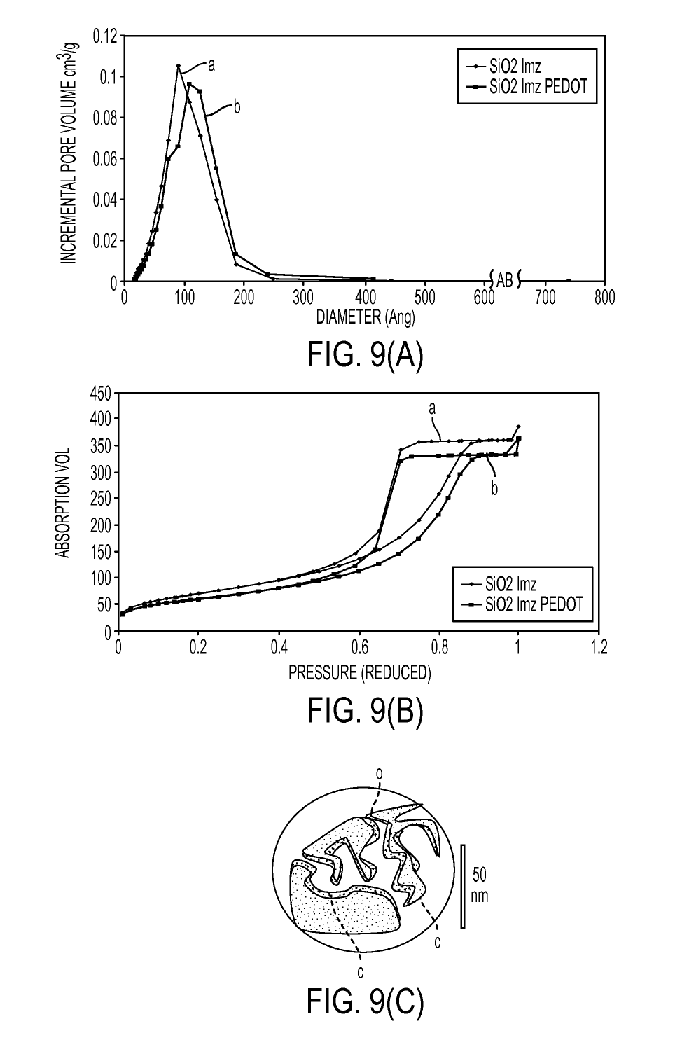

PEDOT retains a substantial amount of its mesoporosity after introduction of PEDOT. As shown in FIG. 9a, PEDOT retains about 85% of its mesoporosity.

### Example 6

Various properties of the mesoporous PEDOT monolith produced in accordance with the method disclosed in Example 1 were investigated.

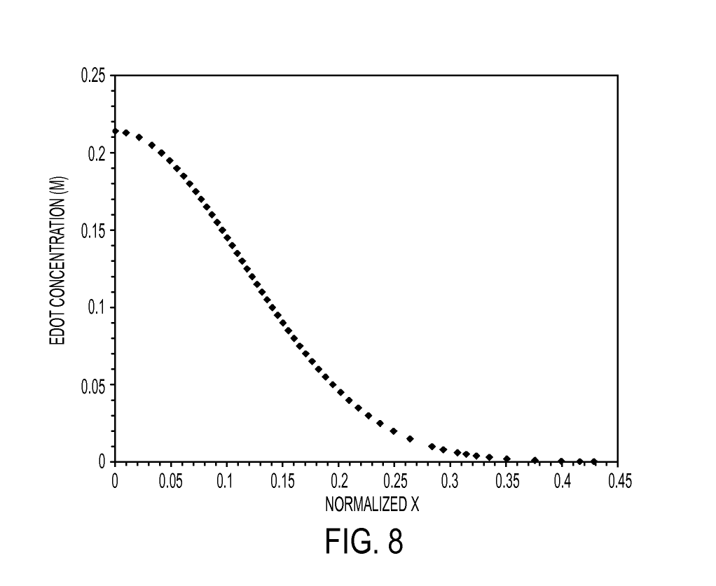

FIG. 8 shows the steady-state concentration profile of unreacted EDOT that persisted during polymerization of EDOT, until polymerization was complete. The figure analyzes the concentration of the monomer in solution before it is reacted. The normalized distance x represents a unitless distance into the silica monolith; the center line of the monolith is x=1. The solution of the inset second-order ODE is plotted.

FIGS. 9(a)-9(b) evaluated a sample of silicon dioxide imidazole mesoporous substrate shown in graph a and a sample of silicon dioxide imidazole PEDOT shown in graph b. FIG. 9(a) is a graph of pore volume as a function of pore diameter for a silica substrate and the fully formed mesoporous silica-PEDOT monolith, wherein the PEDOT was formed on the on mesopore walls. The graph indicates that 85% of the monolith's mesoporosity was retained (i.e. a 264 m²/g surface area before PEDOT introduction and a 224 m²/g surface area after PEDOT introduction; a 0.61 cm³/g pore volume before PEDOT introduction and a 0.52 cm³/g pore volume after PEDOT introduction).

FIG. 9(b) shows a graph of absorption volume as a function of reduced, normalized pressure P/Po. FIG. 9(c) shows the suggested variability in PEDOT deposition, including bare and occluded regions, o, and areas in which there is complete PEDOT coverage, c.

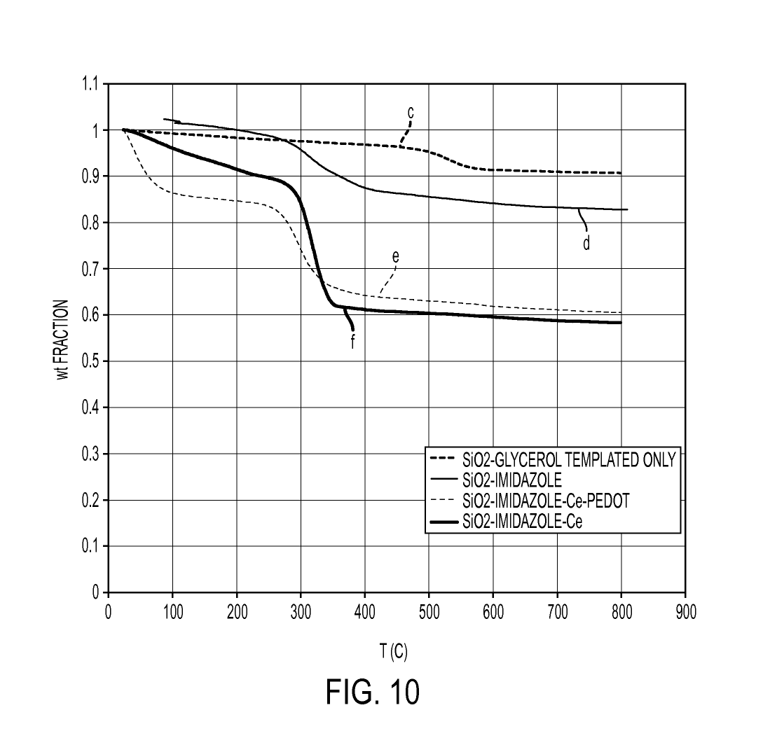

FIG. 10 is a thermogravimetric analysis showing the weight fraction of silicon dioxide monoliths impregnated with glycerol template only (c), imidazole only (d), imidazole and PEDOT with cerium (III) extracted (e) and imidazole with unreacted cerium (IV) (f).

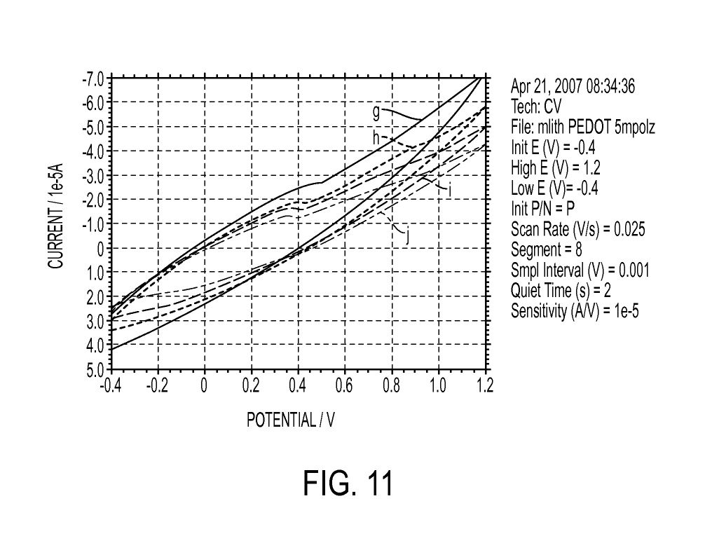

FIG. 11 is a graph of cyclic voltammograms of a finished monolith weighing 26.5 mg, containing 11.2 wt % PEDOT, and immersed in 7.5 wt % LiClO4 in 1-propanol. Graph (g) shows a scan rate of 0.15 volts/second; graph (h) shows a scan rate of 0.075 volts/second; graph (i) shows a scan rate of 0.05 volts/second and graph (j) shows a scan rate of 0.025 volts/second. The initial scans are shown. The effective resistance at a scan rate of 0.15 volts/second is 15.87 kOhms. The graph shows the electroactivity of the monoliths as a function of electrical scan rate.

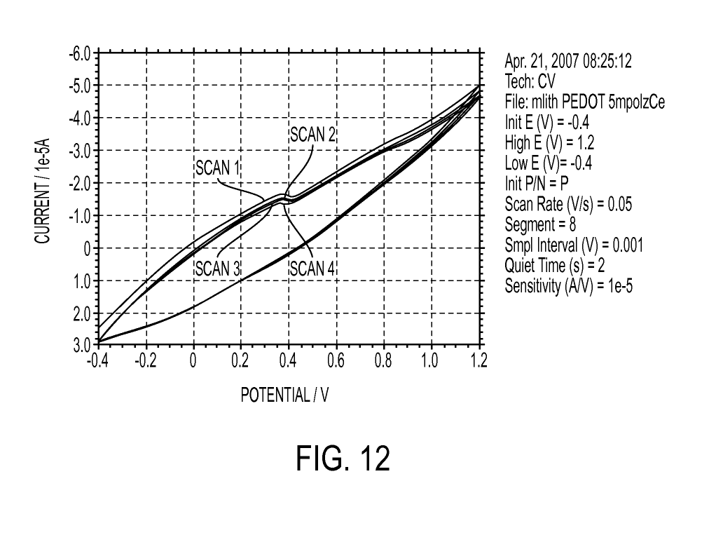

FIG. 12 shows cyclic voltammograms of a finished monolith weighing 26.5 mg, containing 11.2 wt % PEDOT, and immersed in 7.5 wt % LiClO₄ in 1-propanol at a scan rate of 0.05 volts/second. The monolith retains its electrical activity even after repeated cyclic voltametric scanning. The repeated scans were performed at a one scan rate.

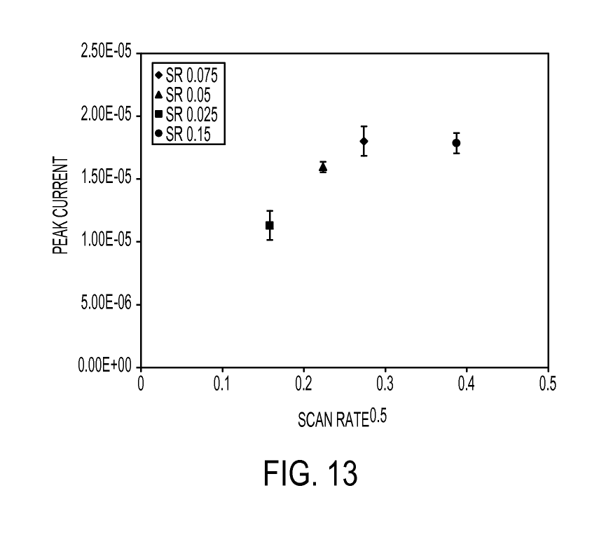

FIG. 13 is a graph of peak current as a function of the square root of the scan rate for a finished monolith weighing 26.5 mg, containing 11.2 wt % PEDOT, and immersed in 7.5 wt % LiClO₄ in 1-propanol. The scan rates in volts/sec are given in the legend. Notably at lower scan rates, designated by the first three data points, the reaction is reversible. At higher scan rates, i.e. the fourth data point, the reaction is no longer reversible.

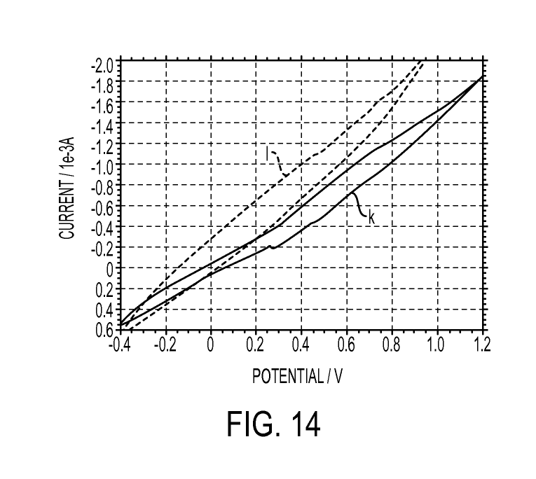

FIG. 14 is a graph of cyclic voltammograms of monolith in 30/70 ionic liquid (N-methylimidazolium hexafluorophosphate)/methanol. Scan rates 0.025 volts/second (k) and 0.05 volts/second (1), were used. FIG. 14 shows the conductivity of the PEDOT in the monolith, which is proportional to the slope of the scan rate.

Having described the preferred embodiments of the invention which are intended to be illustrative and not limiting, it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, the intended scope of protection is set forth in the appended claims.

1-15. (canceled)

16. A method for fabricating a mesoporous monolith comprising the steps of:
providing a mesoporous substrate precursor,
synthesizing a mesoporous substrate from the mesoporous substrate precursor;
attaching an imidazole moiety-containing compound to a surface of the mesoporous substrate;
binding a metal to said imidazole moieties; and
polymerizing a monomer via a stoichiometric process to produce a mesoporous monolith comprising a conducting polymer.

17. The method of claim 16, wherein said binding a metal comprises functionalizing the mesoporous substrate bearing the imidazole moiety-containing compound by chelating iron (III) salt.

18. The method of claim 16, wherein the conducting polymer is substantially a monolayer.

19. The method of claim 16, wherein the conducting polymer is polymerized in situ in the mesoporous substrate.

20. A method for fabricating a mesoporous monolith comprising the steps of:
providing a mesoporous substrate precursor,
synthesizing a mesoporous substrate from the mesoporous substrate precursor;
attaching an imidazole moiety-containing compound to a surface of the mesoporous substrate;
binding a metal to said imidazole moieties; and
polymerizing a monomer via a stoichiometric process to produce a mesoporous monolith comprising a conducting polymer,
wherein the conductive polymer is poly(3,4-diethylenedioxythiophene).

21. The method of claim 16, wherein the mesoporous monolith comprising a conducting polymer has an internal pore surface area of about 200 m²/g to about 400 m²/g.

22. The method of claim 16, wherein the mesoporous monolith comprising a conducting polymer has a pore volume of about 0.7 cm³/g to about 1.0 cm³/g, an internal pore surface area of about 50 m²/g to about 600 m²/g, and an average pore diameter from about 1 nm to about 50 nm.

23. The method of claim 16, wherein the mesoporous monolith comprising a conducting polymer has a resistance of about 1 kΩ/mg to about 1 Ω/mg.

24. The method of claim 16, wherein the mesoporous monolith comprising a conducting polymer has a resistance of about 1 kΩ/mg to about 1 Ω/mg and a transparency of about 11-15% at a wavelength of 800 nm.

25. The method of claim 16, wherein the mesoporous substrate comprises a silica.

26. The method of claim 16, wherein the conducting polymer is selected from the group consisting of poly(3,4-diethylenedioxythiophene), polythiophene, polypyrrole, polyaniline and mixtures thereof.

27. The method of claim 16, wherein the conducting polymer is substantially a monolayer.

28. The method of claim 16, wherein the conducting polymer substantially fills pores of the monolith.

29. The method of claim 16, wherein the mesoporous monolith comprising a conducting polymer has an average pore diameter from about 5 nm to about 20 nm.

30. The method of claim 16, wherein the mesoporous monolith comprising a conducting polymer retains at least about 60% of its mesoporosity.

31. The method of claim 16, wherein said metal is a metal salt comprising a metal selected from the group consisting of Ce4⁺, iron (III), Sc(III), Cr(IV),0 Mn(III), Co(III), Ni(II), Cu(III), Ru(III), Sn(IV), a lanthanide, Nd(III), Sm(III), Gd(III), Eu(III), Yb(III), and Lu(III).

32. A method for fabricating a mesoporous monolith comprising the steps of:
providing a mesoporous substrate precursor,
hydrothermally treating the mesoporous substrate precursor;
substantially completely drying the mesoporous substrate precursor to form a mesoporous substrate having pores;
attaching an imidazole moiety-containing compound to the pores the mesoporous substrate;
binding a metal to said imidazole moieties; and
polymerizing a monomer via a stoichiometric process, thereby at least partially filling the pores of the mesoporous substrate with a conducting polymer.

33. The method of claim 32, wherein the hydrothermal treatment step comprises saturating the mesoporous substrate precursor in water and heating the mesoporous substrate precursor to a temperature of from about 70° C. to about 90° C.

34. The method of claim 32, wherein a porogen is added to the mesoporous substrate precursor prior to the hydrothermal treatment step.

35. The method of claim 32, wherein the porogen is glycerol.
